(19) United States
(12) Patent Application Publication
(10) Pub. No.: US 2025/0052918 A1
(43) Pub. Date: Feb. 13, 2025

(54) Unsupervised Framework For Decoupling Signals Or Noise From Data

(71) Applicant: Landmark Graphics Corporation, Houston, TX (US)

(72) Inventors: Satyan Singh, Abingdon (GB); Konstantin Osypov, Houston, TX (US); Graham Baines, Abingdon (GB)

(73) Assignee: Landmark Graphics Corporation, Houston, TX (US)

(21) Appl. No.: 18/233,054

(22) Filed: Aug. 11, 2023

(51) Int. Cl. G01V 1/04; G01V 1/38

(52) U.S. Cl. CPC G01V 1/04; G01V 1/38

(57) ABSTRACT

A method for creating a generated signal which includes training a signal generator using a physics informed constraint, providing, to the signal generator, raw data that includes a signal and noise, where the signal generator processes the raw data to create the generated signal, and obtaining the generated signal from the signal generator.

### BACKGROUND

The oil and gas industry may use seismology to gather data about subterranean formations and structures, in pursuit of locating resource deposits. In some cases, seismology data is gathered over a body of water using a vessel and an array of sensors towed over the water. Raw data gathered in such environments may need to be processed before the data can be analyzed for locating resource deposits. Tools to process the data may involve human input and produce data that is not ideal for analysis.

### BRIEF DESCRIPTION OF DRAWINGS

These drawings illustrate certain aspects of some examples of the present disclosure and should not be used to limit or define the disclosure.

FIG. 1 is a diagram of an example surveying environment.

FIG. 2 is a diagram of an example computing environment.

FIG. 3 is a diagram of various example software and data components.

FIG. 4 is a flowchart of a method for training data generators using a physics informed trainer.

FIG. 5 is a flowchart of a method for training data generators using an imitation trainer.

FIG. 6 is a flowchart of a method for training data generators using a cycle loss trainer.

FIG. 7 is a flowchart of a method for creating a generated signal.

FIG. 8A is a graphical depiction of example raw data.

FIG. 8B is a graphical depiction of an example signal.

FIG. 8C is a graphical depiction of example noise.

FIG. 9 is a graphical depiction of an example knowledge graph.

### DETAILED DESCRIPTION

### Overview and Advantages

In general, this application discloses one or more embodiments of methods and systems for using machine learning to process raw seismology data. Specifically, raw data may include a (desired) signal component(s) and/or an (unwanted) noise component(s). However, conventional techniques to “filter” out the noise or to decouple multiple signals, often filter too much data and remove important ‘signal’ data (“signal leakage”) and/or remove too little data leaving noise that clutters and obscures the desired signal.

As disclosed herein, by using one or more machine learning techniques, software (a “signal generator”) may be configured to more accurately and efficiently “filter” out the noise (an/or other unwanted signal(s)) from the raw data. Specifically, using underlying knowledge of the properties of the signal and noise, one or more “physics informed” constraints may be specified that guide the training of the machine learning models.

By training the models with physics informed constraints, neural networks may be built and modified (e.g., trained) to parse the signal and noise data to produce signal data that noticeably superior to signal data obtained with conventional methods. Further, such physics informed machine learning models may utilize other, additional properties of the signal and noise that are known and/or weakly known from general knowledge

Generating signal data using one or more machine learning model(s) reduces the time, energy, and money traditionally required to process raw data. Further, the signal data generated may be markedly superior to signal data acquired using conventional processing techniques.

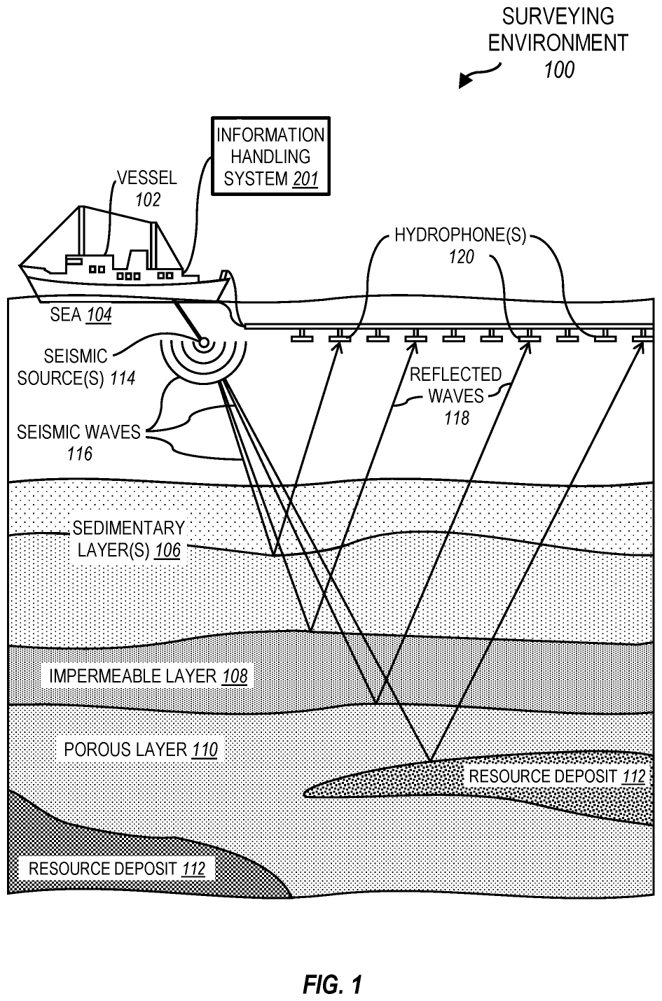

—FIG. 1—

FIG. 1 is a diagram of an example surveying environment. Surveying environment 100 may include vessel 102 on sea 104, using seismology to generate and collect data related to one or more resource deposit(s) 112. Each of these components is described below.

Vessel 102 is a structure used to support one or more seismic source(s) 114 and one or more hydrophone(s) 120. In any embodiment, vessel 102 may be less dense than the liquid composing sea 104, and therefore vessel 102 will have buoyancy sufficient to prevent the entirety of vessel 102 from submerging into sea 104. Vessel 102 may navigate on the surface of sea 104 to move one or more seismic source(s) 114 and one or more hydrophone(s) 120 to regions where seismic data may be collected (e.g., into information handling system 201).

Sea 104 is a body of (mostly) water, upon which vessel 102 may float. In any embodiment, non-limiting examples of sea 104 include an ocean, gulf, lake, pond, reservoir, river, and stream.

Sedimentary layer 106 is a collection of minerals (e.g., rocks) and/or organic matter forming a seabed in sea 104. Generally, sedimentary layer 106 is porous as the liquid(s) of sea 104 may interstitially penetrate between the individual objects forming sedimentary layer 106.

Impermeable layer 108 is a formation of nonporous rock through which the liquid(s) of sea 104 cannot penetrate. In any embodiment, impermeable layer 108 separates two porous layers (e.g., sedimentary layer 106, porous layer 110). Impermeable layer 108 may act to prevent the diffusion of fluids in one or more resource deposit(s) 112 with sea 104, as the fluids thereof are kept physically isolated by the low porosity of impermeable layer 108.

Porous layer 110 is a formation of rocks which allows for the flow of fluids (i.e., gases and/or liquids) to move therein. A non-limiting example of porous layer 110 is an aquifer providing for the movement and storage of groundwater. In any embodiment, porous layer 110 allows for the movement and storage of resource deposit(s) 112.

Resource deposit 112 is an aggregation of matter, where the matter may store energy in the chemical bonds (i.e., a resource). Non-limiting examples of a resource are any fluid hydrocarbon (e.g., petroleum, natural gas, etc.).

Seismic source 114 is a hardware device which generates seismic waves 116. In any embodiment, seismic source 114 may be controlled via information handling system 201 and periodically generate seismic waves 116 (e.g., on a schedule, and/or manually activated by a user). Non-limiting examples of seismic source 114 include a seismic airgun which releases a burst of compressed gas, an electrical discharge sound device (e.g., boomers, sparkers, etc.), and a sonic navigation and ranging (sonar) device.

Seismic waves 116 are acoustic waves, generated from seismic source 114, manifesting as changes in pressure (e.g., changes in the density of fluid(s)) that propagate through sea 104, sedimentary layer(s) 106, impermeable layer 108, porous layer 110, and resource deposit(s) 112. Seismic waves 116 may travel in all directions from seismic source 114 (e.g., spherically outward).

Reflected waves 118 are seismic waves 116 that have reflected (e.g., “bounced”) off of one or more object(s) in sea 104, sedimentary layer(s) 106, impermeable layer 108, porous layer 110, or resource deposit(s) 112. In any embodiment, after reflecting, reflected waves 118 may be (re) directed in all directions (e.g., spherically outward), including towards hydrophone(s) 120. When seismic waves 116 interact and reflect off of one or more objects in the various layer(s), the resulting reflected waves 118 may be altered (via a change in amplitude, frequency, etc.) from the original seismic waves 116. As non-limiting examples, (unaltered) seismic waves 116 may have a different frequency than reflected waves 118 emanating from impermeable layer 108, which may also have a different frequency than reflected waves 118 emanating from resource deposit 112.

Additionally, in any embodiment, reflected waves 118 that penetrate further into the various layers (e.g., into porous layer 110) may take a longer duration to travel deeper, reflect off of an object, travel back upward, and impact hydrophone 120, compared to reflected waves 118 that bounce back from a shallower depth (e.g., in sedimentary layer 106).

Hydrophone 120 is a hardware sensor device (e.g., a microphone) which detects sounds (e.g., seismic waves 116, reflected waves 118) in a liquid environment. Hydrophone 120 may work by detecting changes in pressure caused by sound (e.g., from seismic waves 116, reflected waves 118) and converting those detected pressure changes into data. In any embodiment, hydrophone 120 may be configured to detect the amplitude, frequency, and/or time of detected sounds. Hydrophone 120 may be operatively connected to information handling system 201, where data generated by hydrophone 120 may be stored (e.g., as raw data 350).

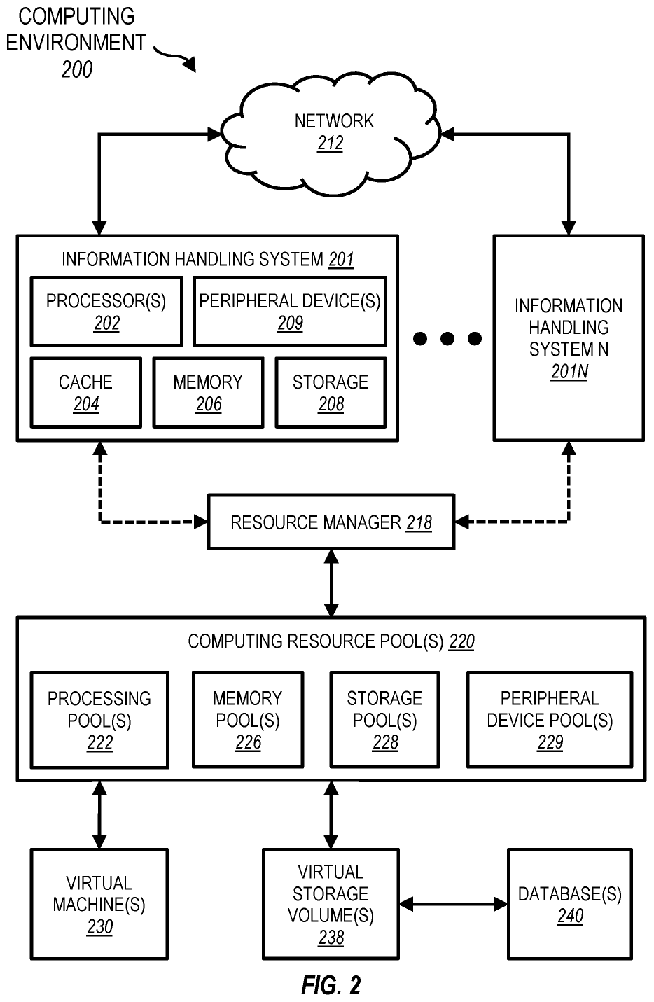

Information handling system 201 is a computing system which may be operatively connected to vessel 102 (and/or other various components of the surveying environment 100). In any embodiment, information handling system 201 may utilize any suitable form of wired and/or wireless communication to send and/or receive data to and/or from other components of surveying environment 100. In any embodiment, information handling system 201 may receive a digital telemetry signal, demodulate the signal, display data (e.g., via a visual output device), and/or store the data. In any embodiment, information handling system 201 may send a signal (with data) to one or more components of surveying environment 100 (e.g., to control seismic source 114, hydrophone(s) 120, vessel 102, etc.). Additional details regarding information handling system 201 may be found in the description of FIG. 2.

—FIG. 2—

FIG. 2 is a diagram of an example computing environment. Computing environment 200 may include one or more information handling system(s) 201 connected via network 212. Further, resource manager 218 may aggregate and manage the allocation of the computing resources (of one or more information handling system(s) 201) into computing resource pool(s) 220. Those computing resource pool(s) 220 may then be allocated to various virtualized and/or logical components (e.g., virtual machine(s) 230, virtual storage volume(s) 238, etc.). Each of these components is described below.

Information handling system 201 is a hardware computing device which may be utilized to perform various steps, methods, and techniques disclosed herein (e.g., via the execution of software). In any embodiment, information handling system 201 may include one or more processor(s) 202, cache 204, memory 206, storage 208, and/or one or more peripheral device(s) 209. Any two or more of these components may be operatively connected via a system bus (not shown) that provides a means for transferring data between those components. Although each component is depicted and disclosed as individual functional components, these individual components may be combined (or divided) into any possible combination or configuration of components.

A system bus is a system of hardware connections (e.g., sockets, ports, wiring, conductive tracings on a printed circuit board (PCB), etc.) used for sending (and receiving) data to (and from) each of the components connected thereto. In any embodiment, a system bus allows for communication via an interface and protocol (e.g., inter-integrated circuit (I2C), peripheral component interconnect (express) (PCI (e)) fabric, etc.) that may be commonly recognized by the components utilizing the system bus. In any embodiment, a basic input/output system (BIOS) may be configured to transfer information between the components using the system bus (e.g., during initialization of information handling system 201).

In any embodiment, information handling system 201 may additionally include internal physical interface(s) (e.g., serial advanced technology attachment (SATA) ports, peripheral component interconnect (PCI) ports, PCI express (PCIe) ports, next generation form factor (NGFF) ports, M.2 ports, etc.) and/or external physical interface(s) (e.g., universal serial bus (USB) ports, recommended standard (RS) serial ports, audio/visual ports, etc.). Internal physical interface(s) and external physical interface(s) may facilitate the operative connection to one or more peripheral device(s) 209.

Non-limiting examples of information handling system 201 include a general purpose computer (e.g., a personal computer, desktop, laptop, tablet, smart phone, etc.), a network device (e.g., switch, router, multi-layer switch, etc.), a server (e.g., a blade-server in a blade-server chassis, a rack server in a rack, etc.), a controller (e.g., a programmable logic controller (PLC)), and/or any other type of computing device with the aforementioned capabilities. Further, information handling system 201 may be operatively connected to another information handling system 201 via network 212 in a distributed computing environment. As used herein, a “computing device” may be equivalent to an information handling system.

Processor 202 is a hardware device which may take the form of an integrated circuit configured to process computer-executable instructions (e.g., software). Processor 202 may execute (e.g., read and process) computer-executable instructions stored in cache 204, memory 206, and/or storage 208. Processor 202 may be a self-contained computing system, including a system bus, memory, cache, and/or any other components of a computing device. Processor 202 may include multiple processors, such as a system having multiple, physically separate processors in different sockets, or a system having multiple processor cores on a single physical chip. A multi-core processor may be symmetric or asymmetric. Multiple processors 202, and/or processor cores thereof, may share resources (e.g., cache 204, memory 206) or may operate using independent resources.

Non-limiting examples of processor 202 include general-purpose processor (e.g., a central processing unit (CPU)), an application specific integrated circuit (ASIC), a programmable gate array (PGA), a field programmable gate array (FPGA), a digital signal processor (DSP), and any digital or analog circuit configured to perform operations based on input data (e.g., execute program instructions).

Cache 204 is one or more hardware device(s) capable of storing digital information (e.g., data) in a non-transitory medium. Cache 204 expressly excludes transitory media (e.g., transitory waves, energy, carrier signals, electromagnetic waves, signals per se, etc.). Cache 204 may be considered “high-speed”, having comparatively faster read/write access than memory 206 and storage 208, and therefore utilized by processor 202 to process data more quickly than data stored in memory 206 or storage 208. Accordingly, processor 202 may copy needed data to cache 204 (from memory 206 and/or storage 208) for comparatively speedier access when processing that data. In any embodiment, cache 204 may be included in processor 202 (e.g., as a subcomponent). In any embodiment, cache 204 may be physically independent, but operatively connected to processor 202.

Memory 206 is one or more hardware device(s) capable of storing digital information (e.g., data) in a non-transitory medium. Memory 206 expressly excludes transitory media (e.g., transitory waves, energy, carrier signals, electromagnetic waves, signals per se, etc.). In any embodiment, when accessing memory 206, software (executed via processor 202) may be capable of reading and writing data at the smallest units of data normally accessible (e.g., “bytes”). Specifically, memory 206 may include a unique physical address for each byte stored thereon, thereby enabling the ability to access and manipulate (read and write) data by directing commands to a specific physical address associated with a byte of data (i.e., “random access”). Non-limiting examples of memory 206 devices include flash memory, random access memory (RAM), dynamic RAM (DRAM), static RAM (SRAM), resistive RAM (ReRAM), read-only memory (ROM), and electrically erasable programmable ROM (EEPROM). In any embodiment, memory 206 devices may be volatile or non-volatile.

Storage 208 is one or more hardware device(s) capable of storing digital information (e.g., data) in a non-transitory medium. Storage 208 expressly excludes transitory media (e.g., transitory waves, energy, carrier signals, electromagnetic waves, signals per se, etc.). In any embodiment, the smallest unit of data readable from storage 208 may be a “block” (instead of a “byte”). Prior to reading and/or manipulating the data on storage 208, one or more block(s) may be copied to an intermediary storage medium (e.g., cache 204, memory 206) where the data may then be accessed in “bytes” (e.g., via random access). In any embodiment, data on storage 208 may be accessed in “bytes” (like memory 206). Non-limiting examples of storage 208 include integrated circuit storage devices (e.g., a solid-state drive (SSD), Non-Volatile Memory Express (NVMe), flash memory, etc.), magnetic storage devices (e.g., a hard disk drive (HDD), floppy disk, magnetic tape, diskette, cassettes, etc.), optical media (e.g., a compact disc (CD), digital versatile disc (DVD), etc.), and printed media (e.g., barcode, quick response (QR) code, punch card, etc.).

As used herein, “non-transitory computer readable medium” means cache 204, memory 206, storage 208, and/or any other hardware device capable of non-transitorily storing and/or carrying data.

Peripheral device 209 is a hardware device configured to send (and/or receive) data to (and/or from) information handling system 201 via one or more internal and/or external physical interface(s). Any peripheral device 209 may be categorized as one or more “types” of computing devices (e.g., an “input” device, “output” device, “communication” device, etc.). However, such categories are not comprehensive and are not mutually exclusive. Such categories are listed herein strictly to provide understandable groupings of the potential types of peripheral devices 209. As such, peripheral device 209 may be an input device, an output device, a communication device, and/or any other optional computing component.

An input device is a hardware device that receives data into information handling system 201. In any embodiment, an input device may be a human interface device which facilitates user interaction by collecting data based on user inputs (e.g., a mouse, keyboard, camera, microphone, touchpad, touchscreen, fingerprint reader, joystick, gamepad, etc.). In any embodiment, an input device may collect data based on raw inputs, regardless of human interaction (e.g., any sensor, logging tool, audio/video capture card, etc.). In any embodiment, an input device may be a reader for accessing data on a non-transitory computer readable medium (e.g., a CD drive, floppy disk drive, tape drive, scanner, etc.).

An output device is a hardware device that sends data from information handling system 201. In any embodiment, an output device may be a human interface device which facilitates providing data to a user (e.g., a visual display monitor, speakers, printer, status light, haptic feedback device, etc.). In any embodiment, an output device may be a writer for facilitating storage of data on a non-transitory computer readable medium (e.g., a CD drive, floppy disk drive, magnetic tape drive, printer, etc.).

A communication device is a hardware device capable of sending and/or receiving data with one or more other communication device(s) (e.g., connected to another information handling system 201 via network 212). A communication device may communicate via any suitable form of wired interface (e.g., Ethernet, fiber optic, serial communication etc.) and/or wireless interface (e.g., Wi-Fi® (Institute of Electrical and Electronics Engineers (IEEE) 802.11), Bluetooth® (IEEE 802.15.1), etc.) and utilize one or more protocol(s) for the transmission and receipt of data (e.g., transmission control protocol (TCP), user datagram protocol (UDP), internet protocol (IP), remote direct memory access (RDMA), etc.). Non-limiting examples of a communication device include a network interface card (NIC), a modem, an Ethernet card/adapter, and a Wi-Fi® card/adapter.

An optional computing component is any hardware device that operatively connects to information handling system 201 and extends the capabilities of information handling system 201. Non-limiting examples of an optional computing components include a graphics processing unit (GPU), a data processing unit (DPU), and a docking station.

As used herein, “software” (e.g., “code”, “algorithm”, “application”, “routine”) is data in the form of computer-executable instructions. Processor 202 may execute (e.g., read and process) software to perform one or more function(s). Non-limiting examples of functions may include reading existing data, modifying existing data, generating new data, and using any capability of information handling system 201 (e.g., reading existing data from memory 206, generating new data from the existing data, sending the generated data to a GPU to be displayed on a monitor). Although software physically persists in cache 204, memory 206, and/or storage 208, one or more software instances may be depicted, in the figures, as an external component of any information handling system 201 that interacts with one or more information handling system(s) 201.

Network 212 is a collection of connected information handling systems (e.g., 201, 201N) that allows for the exchange of data and/or the sharing of computing resources therebetween. Non-limiting examples of network 212 include a local area network (LAN), a wide area network (WAN) (e.g., the Internet), a mobile network, any combination thereof, and any other type of network that allows for the communication of data and sharing of resources among computing devices operatively connected thereto. One of ordinary skill in the art, having the benefit of this detailed description, would appreciate that a network is a collection of operatively connected computing devices that enables communication between those computing devices.

As used herein, “computing resource” refers to the functional capabilities (and/or portions of functional capabilities) of any component of information handling system 201. As an example, processor 202 may have “processor resources” which may be divided into slices of processor time, any of which may be considered a “computing resource”. Cache 204, memory 206, and storage 208 may each be categorized into their own type of “computing resource”, as well as any smaller increment of storage therein (e.g., “bytes”, “blocks”). As a non-limiting example, a single memory 206 device may be divided into ranges of bytes that may be separately allocated. The storage capacity of the entire memory 206 device may be considered a “computing resource” and any subdivision (byte range) thereof may also be considered a “computing resource”. As another non-limiting example, a network interface card may have a total possible throughput capacity, that total throughput may be divided into portions of bandwidth. The entire throughput may be considered a “computing resource” and any smaller portion of bandwidth may also be considered a “computing resource”.

Resource manager 218 is a software instance that manages the allocation of computing resources. In any embodiment, resource manager 218 is configured (i.e., programmed) to query one or more information handling system(s) 201 to identify the computing resources available therein, and in turn, may aggregate those computing resources into one or more computing resource pool(s) 220, per the type of computing resource. Resource manager 218 may use one or more database(s) (e.g., database 240) to track the availability, allocation, and/or utilization of computing resources (e.g., as computing resource pools(s) 220). In any embodiment, resource manager 218 may create, initialize, stop, and/or terminate one or more virtual machine(s) 230, software container(s), virtual storage volume(s) 238, and/or database(s) 240. Non-limiting examples of resource manager 218 include any orchestrator, hypervisor, and/or container manager.

Computing resource pool 220 is a data structure that includes one or more pool(s) for specific types of computing resources (e.g., processing pool(s) 222, memory pool(s) 226, storage pool(s) 228, peripheral device pool(s) 229, etc.). In any embodiment, computing resource pool 220 is a data structure, created and/or managed by resource manager 218, which tracks the various computing resources of information handling systems 201 in computing environment 200. Computing resource pool(s) 220 may take the form of a table, file, and/or any other data structure capable of including information relevant to computing resources.

Processing pool 222 is a data structure that includes an aggregation of the capabilities and/or functionalities of one or more processor(s) 202 in one or more information handling system(s) 201. In any embodiment, processing pool 222, presents a unified virtual computing resource which may be allocated, by resource manager 218, to any software (e.g., virtual machine 230) and/or virtual storage volume 238.

Memory pool 226 is a data structure that includes an aggregation of the capabilities and/or functionalities of one or more memory 206 device(s) in one or more information handling system(s) 201. In any embodiment, memory pool 226, presents a unified virtual computing resource which may be allocated, by resource manager 218, to any software (e.g., virtual machine 230) and/or virtual storage volume 238.

Storage pool 228 is a data structure that includes an aggregation of the capabilities and/or functionalities of one or more storage 208 device(s) in one or more information handling system(s) 201. In any embodiment, storage pool 228, presents a unified virtual computing resource which may be allocated, by resource manager 218, to any software (e.g., virtual machine 230) and/or virtual storage volume 238.

Peripheral device pool 229 is a data structure that includes an aggregation of the capabilities and/or functionalities of one or more peripheral device(s) 209 in one or more information handling system(s) 201. In any embodiment, peripheral device pool 229, presents a unified virtual computing resource which may be allocated, by resource manager 218, to any software (e.g., virtual machine 230) and/or virtual storage volume 238.

Virtual machine 230 is a software instance which provides a virtual environment in which other software may execute. In any embodiment, virtual machine 230 may be created by resource manager 218, where resource manager 218 allocates some portion of computing resources (e.g., in one or more computing resource pool(s) 220) to virtual machine 230 to initialize and execute. In any embodiment, within virtual machine 230, the computing resources may be aggregated from one or more information handling system(s) 201 (e.g., via computing resource pool(s) 220) and presented as unified “virtual” resources within virtual machine 230 (e.g., virtual processor(s), virtual memory, virtual storage, virtual peripheral device(s), etc.). As computing resource pool(s) 220 are used to generate virtual machine 230, the underlying hardware storing, executing, and processing the operations (of virtual machine 230) may disposed in any number of information handling system(s) 201.

Virtual storage volume 238 is a virtual space for storing data. In any embodiment, virtual storage volume 238 may use any suitable means of underlying device(s) for storing data (e.g., cache 204, memory 206, storage 208) via one or more computing resource pool(s) 220. In any embodiment, virtual storage volume 238 may be managed by virtual machine 230, where virtual machine 230 handles the access (reads/writes), filesystem, redundancy, and addressability of the data stored therein.

Database 240 is a data structure. In any embodiment, database 240 may be stored on virtual storage volume 238 and/or directly on a single information handling system 201. Non-limiting examples of database 240 include a table, a structured file for storing tabular data (e.g., a comma-separated value (CSV) file, a tab-separated value (TSV) file, etc.), and/or any other data structure capable of storing data.

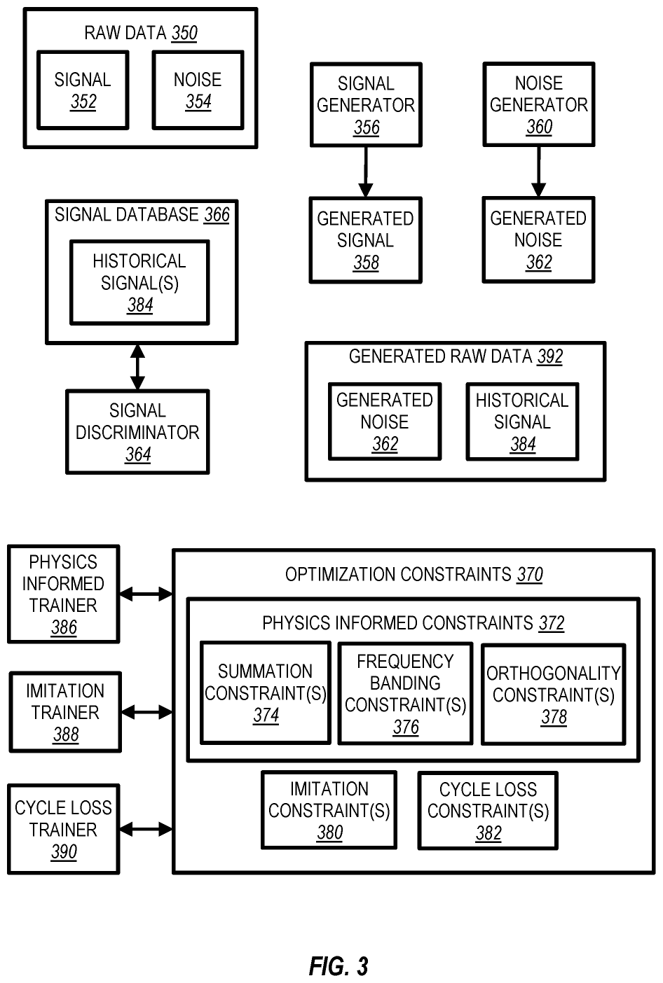

—FIG. 3—

FIG. 3 is a diagram of various example software and data components. Each component is described below.

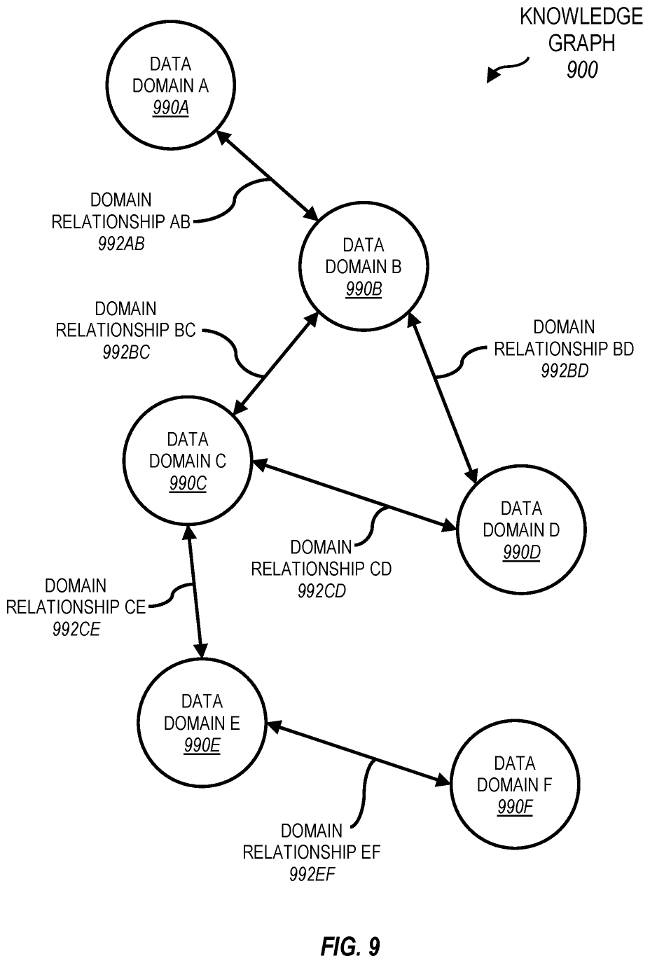

Raw data 350 is data which is collected by one or more sensor(s) (e.g., hydrophone 120). In any embodiment, raw data 350 may include signal 352 and noise 354. Raw data 350 may be the unaltered data stored by information handling system 201 as collected from one or more hydrophone(s) 120. Raw data may include data related to the frequencies and amplitudes of reflected waves 118 at various depths and locations. In any embodiment, raw data 350 includes any data related to the geophysics of the region surveyed. As a non-limiting example, raw data 350 may include any number of data domains 990 in a knowledge graph 900 (see description in FIG. 9) through which raw data 350 may be represented.

Signal 352 is data which is collected by one or more sensor(s) (e.g., hydrophone 120) as part of raw data 350. In any embodiment, signal 352 is the portion of raw data 350 that includes information about the subsea layers (e.g., 106, 108, 110) and potentially, one or more resource deposit(s) 112. In any embodiment, signal 352 is the desired portion of raw data 350.

Noise 354 is data which is collected by one or more sensor(s) (e.g., hydrophone 120) as part of raw data 350. In any embodiment, noise 354 is the portion of raw data 350 that includes unneeded information and may obscure signal 352. In any embodiment, noise 354 is the undesired portion of raw data 350. Non-limiting examples of noise 354 include “swell noise” caused by movement of sea 104, breaking of wind waves, ground roll, and any source of sound other than seismic source(s) 114.

Generally, a data generator is software that processes “input data” to generate “output data” using a data model. In any embodiment, a data generator may be a user accessible front end that allows for usage of the data model (outside of a training environment). Non-limiting examples of a data generator include a command-line interface (CLI), an application programming interface (API), a graphical user interface (GUI), and/or any other means of interaction to initiate the processing of input data to generate output data.

Generally, a data model is data which includes the algorithm, parameters, weights, properties, attributes, and/or other metadata used to configure a data generator to create data (e.g., generate output data using input data). A data model may be trained and tuned using one or more machine learning techniques that optimize the output data (of a data generator using the data model) to have similar properties to existing data of the same type. In any embodiment, one or more types of machine learning algorithm(s) and/or training methods may be utilized. As a non-limiting example, a neural network may be utilized (instead of, or in addition to supplied functions). Such a neural network, constructed of logical nodes and weights to initialize activation functions, may take any suitable form to sufficiently train the data model to achieve the desired generated output data.

Signal generator 356 is a data generator which processes raw data 350 (or generated raw data 392) to create generated signal 358. In any embodiment, signal generator 356 may use one or more data model(s) trained to create generated signal 358 (e.g., trained using optimization constraints 370).

Generated signal 358 is data which resembles signal 352 of raw data 350. In any embodiment, generated signal 358 may be created by signal generator 356 to produce a form of “filtered” raw data 350 (e.g., having mostly signal 352 and lacking any noise 354).

Noise generator 360 is a data generator which processes raw data 350 (or generated raw data 392) to create generated noise 362. In any embodiment, noise generator 360 may use one or more data model(s) trained to create generated noise 362 (e.g., trained using optimization constraints 370).

Generated noise 362 is data which resembles noise 354 of raw data 350. In any embodiment, generated noise 362 may be created by noise generator 360 to produce a form of “filtered” raw data 350 (e.g., having mostly noise 354 and lacking any signal 352).

Signal database 366 is a database (e.g., database 240) which stores data related to one or more historical signal(s) 384. In any embodiment, signal database 366 may be accessed by cycle loss trainer 390 for creating generated raw data 392.

Historical signal 384 is data, in signal database 366, that includes information of existing examples of relatively “clean” signals. In any embodiment, historical signal 384 is existing raw data (e.g., raw data 350) where there is comparatively minimal noise (e.g., noise 354), leaving the signal (e.g., signal 352) to dominate the data therein. In any embodiment, historical signal 384 may not be explicitly “labeled” as optimal signal data but may be a historical example of raw data that is considered to need little (if any) processing to remove noise (as there is little noise). In any embodiment, use of historical signal(s) 384 may provide additional training for signal generator 356 to create more accurate generated signal(s) 358 (e.g., using imitation trainer 388). However, use of use of historical signal(s) 384 (and imitation trainer 388) may not be necessary, as signal generator 356 may be trained using other techniques which allow signal generator 356 to create generated signal(s) 358 that are sufficiently accurate (e.g., with minimal signal leakage, maximal noise removal, etc.).

Generated raw data 392 is data which includes a combination of generated noise 362 and historical signal 384. In any embodiment, generated raw data 392 may be created to resemble raw data 350 with the additional known contours of the component data (generated noise 362 and historical signal 384). Thus, generated raw data 392 may be used to train signal generator 356 to create generated signal 358 resembling historical signal 384.

Signal discriminator 364 is software which is used to calculate a numerical score for input data (e.g., a “signal score”). In any embodiment, signal discriminator 364 provides a higher signal score to input data that resembles authentic signal data and a comparatively lower signal score to data that does not resemble authentic signal data (e.g., noise 354). As a non-limiting example, signal discriminator 364 may be configured to calculate signal scores from 0 to 1, where “0” indicates an input lacking any signal data, and “1” indicates an input that is exclusively signal data or vice versa. Further, in any embodiment, signal discriminator 364 may be configured (or trained) to provide historical signal(s) 384 with scores of “1”.

Optimization constraints 370 is data that provides one or more mathematical constraints, limitations, and/or equations, used for optimization/minimization, when training a data generator. Constraints may be categorized into different “types” of constraints based on the property they define. As a non-limiting example, one type of constraint may be “physics informed”, where a known physical and/or mathematical property is defined such that any data generator (or data model thereof) trained (using the constraint) will output data that is optimized to satisfy the constraint of the physical and/or mathematical property. Optimization constraints 370 may include physics informed constraints 372, imitation constraint 380, and cycle loss constraint 382. Each of these components is described below.

Physics informed constraints 372 is data that provides one or more mathematical constraints, limitations, and/or equations that define a physical property of the input and/or output data. As a non-limiting example, physics informed constraint 372 may be “hard coded” to define a known universal constant and/or equation that defines the mathematical relationship between signal and noise (e.g., the Gravitational constant, Planck's constant, etc.). As another non-limiting example, physics informed constraint 372 may define the relationship between different parts of input data and output data (e.g., the sum of output data must be approximate to the input data). In any embodiment, physics informed constraints 372 may be based on any property that a user desires to constrain the output data of a data generator. Physics informed constraints 372 includes summation constraint 374, frequency banding constraint 376, and orthogonality constraint 378, each described below.

Summation constraint 374 is data which includes a constraint for training a data generator. In any embodiment, signal 352 and noise 354 are the exclusive two components of raw data 350. Thus, a physical relationship of the data may be defined, mathematically, as: raw data=signal+noise. Accordingly, as a constraint for training signal generator 356 and noise generator 360, summation constraint 374 may include an equation defining that property—that the combined sum of generated signal 358 and generated noise 362 should be equivalent to raw data 350 (e.g., raw data=signal_{gen}+noise_{gen}). Thus, for purposes of optimization via minimization, the difference between the raw data 350 and the sum of generated signal 358 and generated noise 362 is minimized, where a “summation error” to minimize is defined (e.g., errorₛᵤₘ=| (signal_{gen}+noise_{gen})−raw data|).

Frequency banding constraint 376 is data which includes a constraint for training a data generator. In any embodiment, signal 352 and/or noise 354 may be known to exist primarily in certain ranges of frequency. Accordingly, a frequency range (or high/low cutoff) may be defined where a data generator is trained to generate data satisfying the frequency range specified. As a non-limiting example, “swell noise” (a component of noise 354) may be known to exist primarily in the range of 2 to 30 hertz. Thus, as a non-limiting example, frequency banding constraint 376 may be defined to create generated noise 362 noise in the range 2 to 30 hertz, where “frequency banding error” is a numerical value of the data existing outside those constraints (e.g., error_{freq-1}=Σ[f(noise_{gen})<2 hz], error_{freq-2}=Σ[f (noise_{gen})>30 hz], and error_{freq}=Σ[error_{freq-n}]).

Orthogonality constraint 378 is data which includes a constraint for training a data generator. In any embodiment, signal 352 and noise 354 may include mutually exclusive latent spaces, such that if the dot product of the two should be 0 (i.e., no value from one can scale a value from the other). That is, as signal 352 and noise 354 do not include any overlapping data, multiplying each datapoint of the latent space of each dataset, respectively, should be 0. Thus, as a non-limiting example, for training signal generator 356 and noise generator 360, orthogonality constraint 378 may include an equation for “orthogonality error” as: errorₒᵣₜₕ=|signal_{gen}·noise_{gen}|. Further, enforcing such a constraint may also reduce “signal leakage” (where portions of signal 352 are noticeably present within generated noise 362) as another mathematical distinction between the two datasets is defined to constrain the outputs.

Imitation constraint 380 is data which includes a constraint for training a data generator. In any embodiment, signal discriminator 364 may be configured to calculate signal score(s) indicating that historical signal(s) 384 include exclusively signal 352 data (e.g., a maximum score of “1”). Thus, as a non-limiting example, imitation constraint 380 may include a property defining generated signal 358 to have a signal score close to “1”, with an “imitation error” defined for minimization (e.g., errorᵢₘᵢₜ=|score (signal_{gen})−1|). Similarly, as a non-limiting example, imitation constraint 380 may include a property defining generated noise 362 to have a signal score close to “0”, with an “imitation error” defined for minimization (e.g., errorᵢₘᵢₜ=score (noise_{gen})).

Cycle loss constraint 382 is data which includes a constraint for training a data generator. In any embodiment, if arbitrary generated noise 362 is added to historical signal 384 (e.g., to form generated raw data 392), signal generator 356 should, theoretically, be able to re-create historical signal 384 as generated signal 358. Thus, as a non-limiting example, cycle loss constraint 382 may include a “cycle loss error” to minimize the difference between generated signal 358 (created from generated raw data 392) and historical signal 384 (e.g., error_{closs}=|signal_{gen}−signalₕᵢₛₜ|).

Generally, a trainer is software programmed to train a data generator using one or more constraint(s). A trainer may train a data generator by (i) analyzing the output data of one or more data generator(s), (ii) comparing the analysis of the output data to one or more optimization constraint(s) 370, (iii) modifying one or more properties of the data model (associated with the data generator), (iv) analyzing the new output data to one or more optimization constraint(s) 370, and (v) further modifying one or more properties of the data model to produce output data that better satisfies the optimization constraint(s) 370 (e.g., via gradient descent of individual constraints, minimization of sum of constraint differential total, etc.)

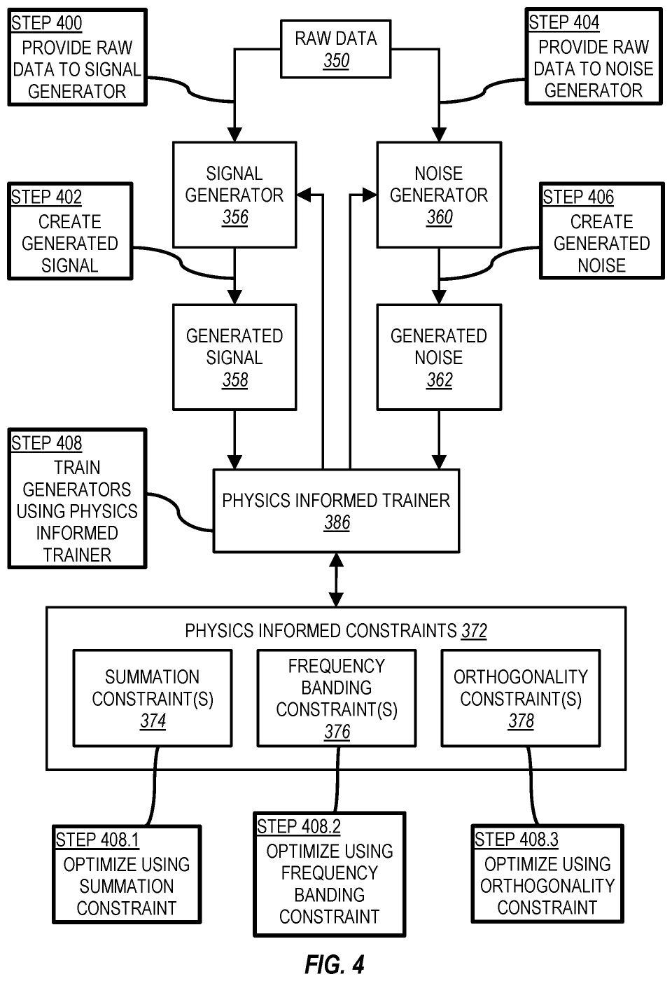

Physics informed trainer 386 is a trainer which uses physics informed constraints 372 to train data generators. In any embodiment, physics informed trainer 386 may train signal generator 356 and noise generator 360 simultaneously and/or independently. Additional details regarding the processes of physics informed trainer 386 are discussed in the description of FIG. 4.

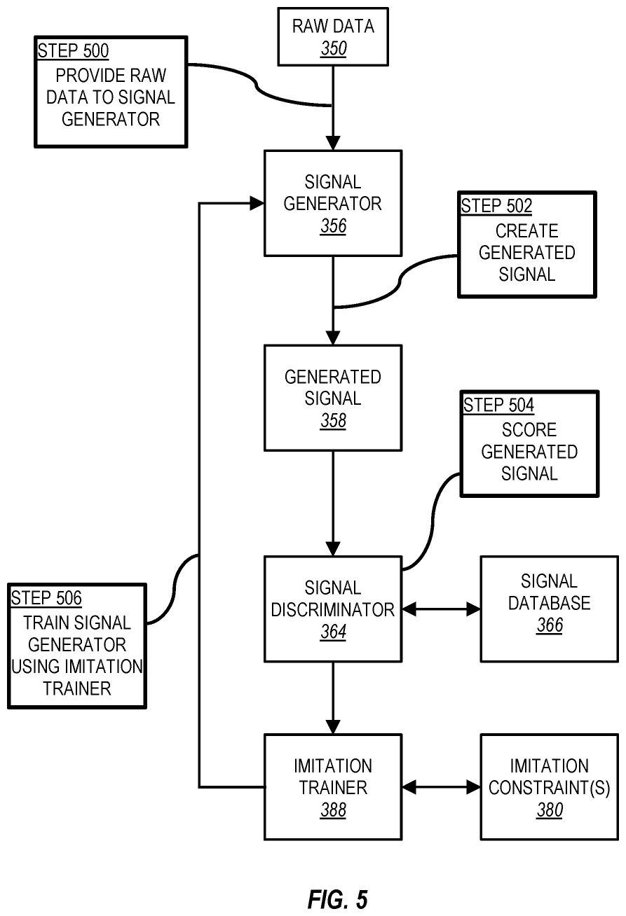

Imitation trainer 388 is a trainer which uses imitation constraint 380 to train data generators. Additional details regarding the processes of imitation trainer 388 are discussed in the description of FIG. 5.

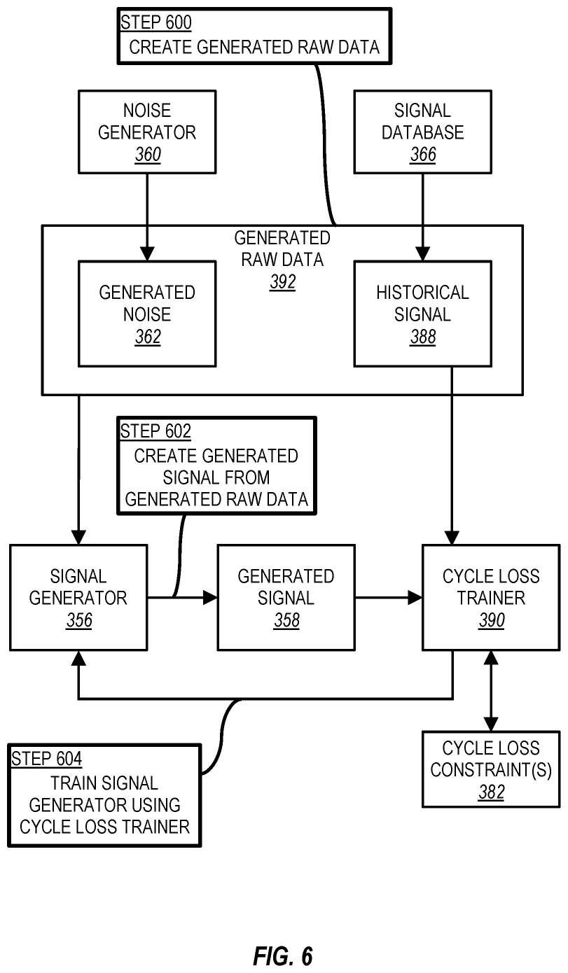

Cycle loss trainer 390 is a trainer which uses cycle loss constraint 382 to train data generators. Additional details regarding the processes of cycle loss trainer 390 are discussed in the description of FIG. 6.

—FIG. 4—

FIG. 4 is a flowchart of a method for training data generators using a physics informed trainer. All or a portion of the method shown may be performed by one or more components of information handling system 201 (see description in FIG. 2) or a user thereof. While the various steps in this flowchart are presented and described sequentially, one of ordinary skill in the relevant art (having the benefit of this detailed description) would appreciate that some or all steps may be executed in different orders, combined, or omitted, and some or all steps may be executed in parallel.

In step 400, raw data 350 is provided to signal generator 356, and signal generator 356 obtains raw data 350. In any embodiment, signal generator 356 may be provided raw data 350 by receiving a location where raw data 350 is stored (e.g., a virtual/physical byte offset and length in memory 206).

In step 402, signal generator 356 creates generated signal 358 from raw data 350, as instructed by an associated data model. In any embodiment, the data model provides a set of instructions (e.g., operations) to perform, based on raw data 350, to create generated signal 358. Generated signal 358 may be fully created when signal generator 356 finishes processing raw data 350 using the associated data model. In any embodiment, generated signal 358 may be stored in any suitable location (e.g., memory 206, storage 208, any combination thereof using virtual storage volume 238, etc.).

In step 404, raw data 350 is provided to noise generator 360, and noise generator 360 obtains raw data 350. In any embodiment, noise generator 360 may be provided raw data 350 by receiving a location where raw data 350 is stored (e.g., a virtual/physical byte offset and length in memory 206).

In step 406, noise generator 360 creates generated noise 362 from raw data 350, as instructed by an associated data model. In any embodiment, the data model provides a set of instructions (e.g., operations) to perform, based on raw data 350, to create generated noise 362. Generated noise 362 may be fully created when noise generator 360 finishes processing raw data 350 using the associated data model. In any embodiment, generated noise 362 may be stored in any suitable location (e.g., memory 206, storage 208, any combination thereof using virtual storage volume 238, etc.).

In step 408, generated signal 358 and generated noise 362 are sent to physics informed trainer 386, and physics informed trainer 386 obtains generated signal 358 and generated noise 362.

Physics informed trainer 386 trains signal generator 356 and noise generator 360. In any embodiment, physics informed trainer 386 uses one or more physics informed constraints 372 to analyze the sufficiency of the generated data per the mathematical operations specified in physics informed constraints 372. After calculating the errors defined in physics informed constraint(s) 372 (explained in steps 408.1, 408.2, and 408.3), physics informed trainer 386 modifies the data model for one or both of signal generator 356 and noise generator 360. Specifically, in any embodiment, physics informed trainer 386 modifies one or more values and/or properties defined in the data model (e.g., the weight of an input to a node, the threshold value required for an activation function of a node, the type of activation function of a node, etc.). In turn, such changes may have some effect on the generated signal 358 and/or generated noise 362 created by the signal generator 356 and/or noise generator 360, respectively.

In step 408.1, physics informed trainer 386 uses summation constraint 374 to analyze generated signal 358 and generated noise 362. Specifically, physics informed trainer 386 reads the equation specified in summation constraint 374 (e.g., errorₛᵤₘ=|(signal_{gen}+noise_{gen})−raw data|) and performs the mathematical operations specified therein. Accordingly, in any embodiment, physics informed trainer 386 combines (via addition) generated signal 358 and generated noise 362 into a single data structure. As a non-limiting example, the amplitudes and frequencies of each dataset are summed at each recorded depth and location, respectively. Physics informed trainer 386 then subtracts raw data 350 from the sum of the generated data to calculate a difference. As a non-limiting example, the amplitudes and frequencies of one dataset are subtracted at each recorded depth and location, respectively, from the other dataset. The output of such an operation is a “difference dataset” that includes the difference in values at each frequency and depth. The sum of all of the differences, within the “difference dataset”, may then be calculated into a single summation error (e.g., via direct summation of all differences, root mean square error all differences, etc.). An “absolute value” (e.g., magnitude) of the summation error may then be calculated (e.g., if negative). The closer the summation error is to 0, the closer signal generator 356 and noise generator 360 are to satisfying summation constraint(s) 374.

In step 408.2, physics informed trainer 386 uses frequency banding constraints 376 to analyze generated signal 358 and generated noise 362. Specifically, physics informed trainer 386 reads the equation specified in frequency banding constraint 376 (e.g., error_{freq-1}=Σ[f(noise_{gen})<2 hz], error_{freq-2}=Σ[f(signal_{gen})>40 hz], and error_{freq}=Σ[error_{freq-n}]) and performs the mathematical operations specified therein. Accordingly, in any embodiment, physics informed trainer 386 identifies all data in generated signal 358 at frequencies above 40 hz. To calculate the error, as a non-limiting example, the amplitude values for all data above 40 hz may be summed into a single “signal band error” value (e.g., error_{freq-2}). Similarly, in any embodiment, physics informed trainer 386 identifies all data in generated noise 362 at frequencies below 40 hz. To calculate the error, as a non-limiting example, the amplitude values for all data below 2 hz may be summed into a single “noise band error” value (e.g., error_{freq-1}). The “signal band error” and “noise band error” may then be summed into a single “frequency banding error” (e.g., error_{freq}). The closer the frequency banding error is to 0, the closer signal generator 356 and noise generator 360 are to satisfying frequency banding constraint(s) 376. In any embodiment, frequencies specified (in frequency banding constraints 376) may depend on the specific physics of raw data 350 acquired in a particular surveying environment 100. Conversely, in any embodiment, some physics may be relatively similar in different surveying environments. As a non-limiting example, a frequency range of 2 to 30-40 hz may be reliably used for swell noise removal.

In step 408.3, physics informed trainer 386 uses orthogonality constraint 378 to analyze generated signal 358 and generated noise 362. Specifically, physics informed trainer 386 reads the equation specified in summation constraint 374 (e.g., errorₒᵣₜₕ=signal_{gen}·noise_{gen}|) and performs the mathematical operations specified therein. Accordingly, in any embodiment, physics informed trainer 386 calculates the dot product of the latent space of generated signal 358 and generated noise 362. The output of the dot product operation is a single “orthogonality error” (the absolute value may be taken, if negative). The closer the orthogonality error is to 0, the closer signal generator 356 and noise generator 360 are to satisfying orthogonality constraint(s) 378. In any embodiment, orthogonality constraint 378 may help to minimize signal 352 leaking into the noise 354 domain, and noise 354 leaking into the signal 352 domain.

After step 408, physics informed trainer 386 makes a determination if a training threshold has been satisfied. If a training threshold has been satisfied, the process may end. However, if a training threshold has not been satisfied, the process may repeat (return to step 400) until a training threshold is satisfied. Non-limiting examples of a training threshold include a specified number of iterations (e.g., 500, 200,000, etc.), a numerical threshold that each error value must fall below (e.g., 0.01), and a numerical threshold that a sum of the error values must fall below (e.g., 0.02).

—FIG. 5—

FIG. 5 is a flowchart of a method for training data generators using an imitation trainer. All or a portion of the method shown may be performed by one or more components of information handling system 201 (see description in FIG. 2) or a user thereof. While the various steps in this flowchart are presented and described sequentially, one of ordinary skill in the relevant art (having the benefit of this detailed description) would appreciate that some or all steps may be executed in different orders, combined, or omitted, and some or all steps may be executed in parallel.

In step 500, raw data 350 is provided to signal generator 356, and signal generator 356 obtains raw data 350. In any embodiment, signal generator 356 may be provided raw data 350 by receiving a location where raw data 350 is stored (e.g., a virtual/physical byte offset and length in memory 206).

In step 502, signal generator 356 creates generated signal 358 from raw data 350, as instructed by an associated data model. In any embodiment, the data model provides a set of instructions (e.g., operations) to perform, based on raw data 350, to create generated signal 358. Generated signal 358 may be fully created when signal generator 356 finishes processing raw data 350 using the associated data model. In any embodiment, generated signal 358 may be stored in any suitable location (e.g., memory 206, storage 208, any combination thereof using virtual storage volume 238, etc.).

In step 504, signal discriminator 364 generates a “signal score” for generated signal 358. In any embodiment, signal discriminator 364 provides a higher score to input data that resembles authentic signal data (e.g., historical signal(s) 384 from signal database 366) and a comparatively lower score to data that does not resemble authentic signal data. Thus, the higher the score calculated for generated signal 358, the more generated signal 358 resembles authentic signal data.

In step 506, the “signal score” is sent to imitation trainer 388, and imitation trainer 388 obtains the “signal score”. Imitation trainer 388 then trains signal generator 356. In any embodiment, imitation trainer 388 uses one or more imitation constraint(s) 380 to analyze the sufficiency of generated signal 358 per the mathematical operations specified in imitation constraint(s) 380.

Specifically, in any embodiment, imitation trainer 388 reads the equation specified in imitation constraint(s) 380 (e.g., errorᵢₘᵢₜ=|score (signal_{gen})−1|) and performs the mathematical operations specified therein. Accordingly, in any embodiment, imitation trainer 388 reforms the signal score to calculate the “imitation error”. As a non-limiting example, imitation trainer 388 subtracts the maximum possible signal score (a value of “1”) and then takes the absolute value of the difference (to ensure a positive value) to obtain the “imitation error”. The closer the imitation error is to 0, the closer signal generator 356 is to satisfying imitation constraint(s) 380.

After calculating the errors defined in imitation constraint(s) 380, imitation trainer 388 modifies the data model of signal generator 356. Specifically, in any embodiment, imitation trainer 388 modifies one or more values and/or properties defined in the data model (e.g., the weight of an input to a node, the threshold value required for an activation function of a node, the type of activation function of a node, etc.). In turn, such changes may have some effect on the generated signal 358 created by the signal generator 356.

After step 506, imitation trainer 388 makes a determination if a training threshold has been satisfied. If a training threshold has been satisfied, the process may end. However, if a training threshold has not been satisfied, the process may repeat (return to step 500) until the training threshold is satisfied. Non-limiting examples of a training threshold include a specified number of iterations (e.g., 500, 200,000, etc.) and a numerical threshold that the imitation error must minimize below (e.g., 0.01).

—FIG. 6—

FIG. 6 is a flowchart of a method for training data generators using a cycle loss trainer. All or a portion of the method shown may be performed by one or more components of information handling system 201 (see description in FIG. 2) or a user thereof. While the various steps in this flowchart are presented and described sequentially, one of ordinary skill in the relevant art (having the benefit of this detailed description) would appreciate that some or all steps may be executed in different orders, combined, or omitted, and some or all steps may be executed in parallel.

In step 600, cycle loss trainer 390 creates generated raw data 392 by combining generated noise 362 and historical signal 384 into a single dataset. In any embodiment, the amplitudes and frequencies of each dataset (generated noise 362 and historical signal 384) are summed at each recorded depth and location, respectively, to create a new dataset (generated raw data 392).

In step 602, generated raw data 392 is provided to signal generator 356, and signal generator 356 obtains generated raw data 392. Signal generator 356 creates generated signal 358 from generated raw data 392, as instructed by an associated data model. In any embodiment, the data model provides a set of instructions (e.g., operations) to perform, based on generated raw data 392, to create generated signal 358. Generated signal 358 may be fully created when signal generator 356 finishes processing generated raw data 392 using the associated data model. In any embodiment, generated signal 358 may be stored in any suitable location (e.g., memory 206, storage 208, any combination thereof using virtual storage volume 238, etc.).

In step 604, generated signal 358 is sent to cycle loss trainer 390, and cycle loss trainer 390 obtains generated signal 358. Cycle loss trainer 390 then trains signal generator 356. In any embodiment, cycle loss trainer 390 uses one or more cycle loss constraint(s) 382 to analyze the sufficiency of generated signal 358 per the mathematical operations specified in cycle loss constraint(s) 382.

Specifically, in any embodiment, cycle loss trainer 390 reads the equation specified in cycle loss constraint(s) 382 (e.g., error_{closs}=|signal_{gen}−signalₕᵢₛₜ|) and performs the mathematical operations specified therein. Accordingly, in any embodiment, cycle loss trainer 390 calculates the difference between generated signal 358 and historical signal 384. As a non-limiting example, the amplitudes and frequencies of one dataset are subtracted at each recorded depth and location, respectively, from the other dataset. The output of such an operation is a “difference dataset” that includes the difference in values at each frequency and depth. The sum of all of the differences, within the “difference dataset”, may then be calculated into a single summation error (e.g., via direct summation of all differences, root mean square error all differences, etc.). Cycle loss trainer 390 then takes the absolute value of the difference (to ensure a positive value) to obtain the “cycle loss error”. The closer the cycle loss error is to 0, the closer signal generator 356 is to satisfying cycle loss constraint(s) 382.

After calculating the errors defined in imitation constraint(s) 380, cycle loss trainer 390 modifies the data model of signal generator 356. Specifically, in any embodiment, cycle loss trainer 390 modifies one or more values and/or properties defined in the data model (e.g., the weight of an input to a node, the threshold value required for an activation function of a node, the type of activation function of a node, etc.). In turn, such changes may have some effect on the generated signal 358 created by the signal generator 356.

After step 604, cycle loss trainer 390 makes a determination if a training threshold has been satisfied. If a training threshold has been satisfied, the process may end. However, if a training threshold has not been satisfied, the process may repeat (return to step 600) until the training threshold is satisfied. Non-limiting examples of a training threshold include a specified number of iterations (e.g., 500, 200,000, etc.) and a numerical threshold that the cycle loss error must minimize below (e.g., 0.01).

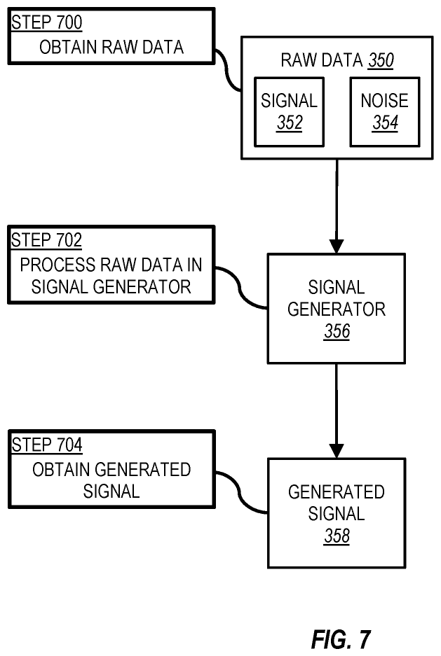

—FIG. 7—

FIG. 7 is a flowchart of a method for creating a generated signal. All or a portion of the method shown may be performed by one or more components of information handling system 201 (see description in FIG. 2) or a user thereof. While the various steps in this flowchart are presented and described sequentially, one of ordinary skill in the relevant art (having the benefit of this detailed description) would appreciate that some or all steps may be executed in different orders, combined, or omitted, and some or all steps may be executed in parallel.

The steps of FIG. 7 may be performed after signal generator 356 has been trained enough (see FIGS. 4-6) to produce generated signal 358 data that is sufficiently acceptable to approximate signal 352 in the original raw data 350.

In step 700, generated raw data 350 is sent to signal generator 356, and signal generator 356 obtains raw data 350. In any embodiment, signal generator 356 may be provided raw data 350 by receiving a location where raw data 350 is stored (e.g., a virtual/physical byte offset and length in memory 206).

In step 702, signal generator 356 processes raw data 350 as specified by the data model associated with signal generator 356. In any embodiment, the data model provides a set of instructions (e.g., operations) to perform, based on raw data 350, to create generated signal 358. Generated signal 358 may be fully created when signal generator 356 finishes processing raw data 350 using the associated data model.

In step 704, generated signal 358 is obtained. In any embodiment, after signal generator 356 finishes processing raw data 350, generated signal 358 may be stored in any suitable location (e.g., memory 206, storage 208, any combination thereof using virtual storage volume 238, etc.).

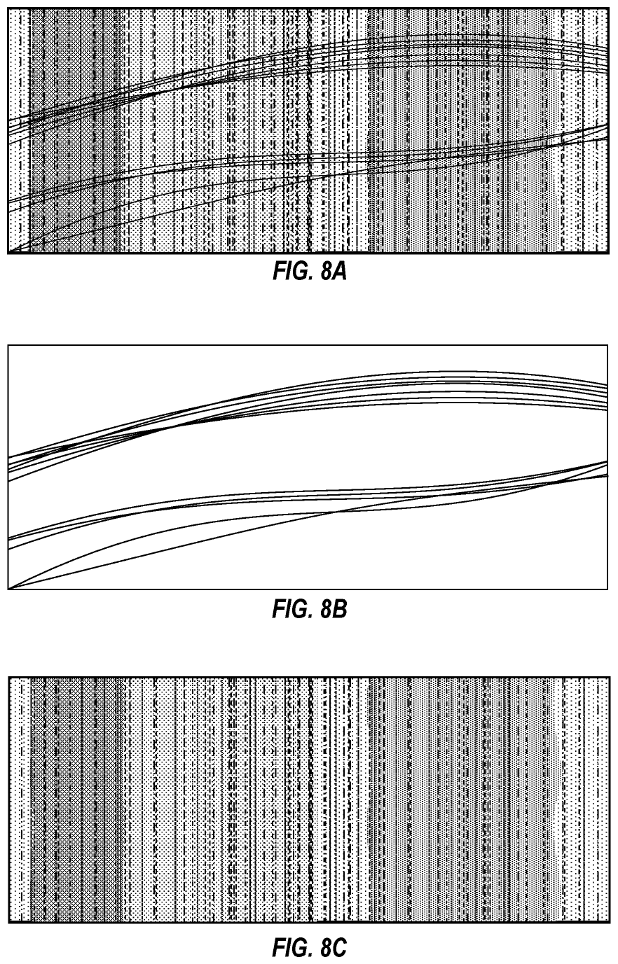

—FIGS. 8A-8C—

FIG. 8A is a graphical depiction of example raw data. As shown in FIG. 8A, there are significant quantities of vertical lines and patterns in the raw data. Further, there are noticeable traces of waves lines spanning (mostly) horizontally. The vertical patterns are an example of noise, and the horizontal lines are an example of signal.

FIG. 8B is a graphical depiction of an example signal. As shown in FIG. 8B, the signal, without any noise, provides clear lines that span horizontally across the depicted area. The example shown in FIG. 8B may also be considered as an example of a generated signal.

FIG. 8C is a graphical depiction of example noise. As shown in FIG. 8C, the noise, without any signal, provides only chaotic and unorganized clusters of data throughout the depicted area. The example shown in FIG. 8C may also be considered as an example of a generated noise.

—FIG. 9—

FIG. 9 is a graphical depiction of an example knowledge graph. In the example shown in FIG. 9, knowledge graph 900 includes six data domains 990 (data domain A 990A, data domain B 990B, data domain C 990C, data domain D 990D, data domain E 990E, and data domain F 990F). Each one of those data domains 990 may be connected to one or more other data domains 990 by a domain relationship 992 (e.g., domain relationship AB 992AB, domain relationship BC 992BC, domain relationship BD 992BD, domain relationship CD 992CD, domain relationship CE 992CE, and domain relationship EF 992EF).

In any embodiment, raw data 350 may be represented as a knowledge graph (e.g., knowledge graph 900). In such a knowledge graph, raw data 350, and/or portions thereof, may be organized into one or more data domains 990 (correlating to one or more attribute(s)) and domain relationships 992 between those data domains 990. In turn, raw data 350 may be interpreted using one or more of those data domain(s) 990 to provide a distinct perspective of the underlying data. Through such a perspective, different portions of the underlying data may be expressed with varying degrees of clarity and intensity. As such, interpreting the data through a data domain 990 may enable the identification of patterns and/or relationships especially apparent in the used data domain(s) 990. Such relationships may then be exploited to isolate a portion of raw data 350 (e.g., signal 352) more efficiently from any other portion(s) of raw data 350 (e.g., noise 354).

Non-limiting examples of data domains 990, into which some or all of raw data 350 may be categorized, include a channel domain, a shot gather domain (e.g., with one seismic source 114 and multiple hydrophones 120), any number of spatial domains, a time domain, a frequency domain (e.g., a transformation of a time domain), a depth domain (e.g., two-way-time), a t-p domain (intercept time (t) compared to slope of depth and lateral distance (p)) (e.g., a transformation of spatial and time domains), and a curvelet domain.

Further examples of spatial domains include each of the three standard spatial domains for three-dimensional space, a midpoint domain for each of the standard spatial domains, a receiver domain (one hydrophone 120 that receives multiple reflected waves 118), and a wave number domain.

During the training of the data model, any trainer (e.g., 386, 388, 390) may identify a data domain 990 (or combination of data domains 990) that are most useful in parsing signal 352 and noise 354. That is, no data domain 990 may be specified as more likely to identify signal 352 or noise 354. Instead, a trainer is provided the entirety of raw data 350, with all of the various data domains 990 defined therein. In turn, the trainer identifies which data domain(s) 990 (perspective of raw data 350) is most useful in isolating and re-creating the relevant portion of raw data 350.

As a non-limiting example, raw data 350 may be categorized into one or more spatial domain(s) and a frequency domain. When interpreting the data through a combination of the frequency domain and a vertical spatial domain, a portion of noise 354 (e.g., swell noise) might be most apparent, while signal 352 is mostly absent. Accordingly, a trainer may identify and use the vertical spatial domain and the frequency domain when generating a portion of the noise 354, as there is an underlying relationship between swell noise and those data domains.

Further, in any embodiment, optimization constraints 370 may be defined to enforce mathematical constraints defined using one or more data domains 990 (e.g., frequency banding constraint(s) 376 using a frequency domain). [applying constraint] within one or more specific data domain(s)

### Solutions and Improvements

The methods and systems described above are an improvement over the current technology as the methods and systems described herein provide using machine learning to process raw seismology data. Specifically, a “signal generator” may be configured to more accurately and efficiently “filter” out the noise from the raw data using underlying knowledge of the properties of the signal and noise. That is, one or more “physics informed” constraints may be specified that guide the training of the machine learning models.

Generating signal data using one or more machine learning model(s) reduces the time, energy, and money traditionally required to process raw data. Further, the signal data generated may be markedly superior to signal data acquired using conventional processing techniques. Specifically, data produced using the machine learning techniques (described herein) more carefully parses signal and noise data, thereby reduce “signal leakage” (signal data filtered out as noise) and further removes more noise from the signal (noise data that would not be filtered conventionally).

### Statements

The systems and methods may comprise any of the various features disclosed herein, comprising one or more of the following statements.

Statement 1: A method for creating a generated signal, comprising: training a signal generator using a physics informed constraint; providing, to the signal generator, raw data comprising a signal and noise, wherein the signal generator processes the raw data to create the generated signal; and obtaining the generated signal from the signal generator.

Statement 2: The method of statement 1, wherein the generated signal is substantially similar to the signal.

Statement 3: The method of statements 1 or 2, wherein training the signal generator further comprises: training a noise generator using the physics informed constraint.

Statement 4: The method of statement 3, wherein the physics informed constraint is a summation constraint, a frequency banding constraint, or an orthogonality constraint.

Statement 5: The method of statement 3, wherein during the training of the signal generator: the signal generator creates the generated signal, and the noise generator creates generated noise.

Statement 6: The method of statement 5, wherein training the signal generator further comprises: combining the generated signal and the generated noise.

Statement 7: The method of statement 5, wherein training the signal generator further comprises: using generated raw data and a cycle loss constraint.

Statement 8: The method of statement 7, wherein the generated raw data comprises the generated noise and a historical signal.

Statement 9: The method of any of statements 1-8, wherein training the signal generator further comprises: using a signal discriminator to score the generated signal.

Statement 10: The method of statement 9, wherein the signal generator is trained using an imitation constraint.

Statement 11: The method of any of statements 1-10, wherein the signal generator uses a data model to create the generated signal.

Statement 12: The method of statement 11, wherein the data model is a neural network.

Statement 13: The method of any of statements 1-12, wherein the raw data is organized into a knowledge graph that comprises a plurality of data domains, and wherein training the signal generator comprises: using the raw data to train the signal generator.

Statement 14: The method of statement 13, wherein the signal generator uses a first data domain, of the plurality of data domains, to create the generated signal.

Statement 15: The method of statement 14, wherein the signal generator uses the first data domain and a second data domain, of the plurality of data domains, to create the generated signal.

Statement 16: The method of statement 15, wherein the first data domain is a frequency domain, and wherein the second data domain is a spatial domain.

Statement 17: The method of statement 15, wherein training the signal generator further comprises: modifying a data model of the signal generator based on the plurality of data domains.

Statement 18: The method of statement 13, wherein a plurality of relationships between data domains, of the plurality of data domains, is defined in the knowledge graph.

Statement 19: The method of statement 18, wherein training the signal generator further comprises: modifying a data model of the signal generator based on the plurality of relationships between the data domains.

Statement 20: An information handling system comprising: memory storing raw data, wherein the raw data comprises a signal and noise; and a processor, herein the processor is configured to perform a method for creating a generated signal, comprising: training a signal generator using a physics informed constraint; providing the raw data to the signal generator, wherein the signal generator processes the raw data to create the generated signal; and obtaining the generated signal from the signal generator.

### General Notes

As it is impracticable to disclose every conceivable embodiment of the technology described herein, the figures, examples, and description provided herein disclose only a limited number of potential embodiments. One of ordinary skill in the art would appreciate that any number of potential variations or modifications may be made to the explicitly disclosed embodiments, and that such alternative embodiments remain within the scope of the broader technology. Accordingly, the scope should be limited only by the attached claims. Further, the compositions and methods are described in terms of “comprising,” “containing,” or “including” various components or steps, the compositions and methods may also “consist essentially of” or “consist of” the various components and steps. Moreover, the indefinite articles “a” or “an,” as used in the claims, are defined herein to mean one or more than one of the elements that it introduces. Certain technical details, known to those of ordinary skill in the art, may be omitted for brevity and to avoid cluttering the description of the novel aspects.

For further brevity, descriptions of similarly named components may be omitted if a description of that similarly named component exists elsewhere in the application. Accordingly, any component described with respect to a specific figure may be equivalent to one or more similarly named components shown or described in any other figure, and each component incorporates the description of every similarly named component provided in the application (unless explicitly noted otherwise). A description of any component is to be interpreted as an optional embodiment-which may be implemented in addition to, in conjunction with, or in place of an embodiment of a similarly-named component described for any other figure.

### Lexicographical Notes

As used herein, adjective ordinal numbers (e.g., first, second, third, etc.) are used to distinguish between elements and do not create any particular ordering of the elements. As an example, a “first element” is distinct from a “second element”, but the “first element” may come after (or before) the “second element” in an ordering of elements. Accordingly, an order of elements exists only if ordered terminology is expressly provided (e.g., “before”, “between”, “after”, etc.) or a type of “order” is expressly provided (e.g., “chronological”, “alphabetical”, “by size”, etc.). Further, use of ordinal numbers does not preclude the existence of other elements. As an example, a “table with a first leg and a second leg” is any table with two or more legs (e.g., two legs, five legs, thirteen legs, etc.). A maximum quantity of elements exists only if express language is used to limit the upper bound (e.g., “two or fewer”, “exactly five”, “nine to twenty”, etc.). Similarly, singular use of an ordinal number does not imply the existence of another element. As an example, a “first threshold” may be the only threshold and therefore does not necessitate the existence of a “second threshold”.

As used herein, the word “data” may be used as an “uncountable” singular noun—not as the plural form of the singular noun “datum”. Accordingly, throughout the application, “data” is generally paired with a singular verb (e.g., “the data is modified”). However, “data” is not redefined to mean a single bit of digital information. Rather, as used herein, “data” means any one or more bit(s) of digital information that are grouped together (physically or logically). Further, “data” may be used as a plural noun if context provides the existence of multiple “data” (e.g., “the two data are combined”).

As used herein, the term “operative connection” (or “operatively connected”) means the direct or indirect connection between devices that allows for interaction in some way (e.g., via the exchange of information). For example, the phrase ‘operatively connected’ may refer to a direct connection (e.g., a direct wired or wireless connection between devices) or an indirect connection (e.g., multiple wired and/or wireless connections between any number of other devices connecting the operatively connected devices).

As used herein, indefinite articles “a” and “an” mean “one or more”. That is, the explicit recitation of “an” element does not preclude the existence of a second element, a third element, etc. Further, definite articles (e.g., “the”, “said”) mean “any one” (of the “one or more” elements) when referring to previously introduced element(s). As an example, there may exist “a processor”, where such a recitation does not preclude the existence of any number of other processors. Further, “the processor receives data, and the processor processes data” means “any one of the one or more processors receives data” and “any one of the one or more processors processes data”. It is not required that the same processor both (i) receive data and (ii) process data. Rather, each of the steps (“receive” and “process”) may be performed by different processors.

What is claimed is:

1. A method for creating a generated signal, comprising:
training a signal generator using a physics informed constraint;
providing, to the signal generator, raw data comprising a signal and noise, wherein the signal generator processes the raw data to create the generated signal; and
obtaining the generated signal from the signal generator.

2. The method of claim 1, wherein the generated signal is substantially similar to the signal.

3. The method of claim 1, wherein training the signal generator further comprises:
training a noise generator using the physics informed constraint.

4. The method of claim 3, wherein the physics informed constraint is a summation constraint, a frequency banding constraint, or an orthogonality constraint.

5. The method of claim 3, wherein during the training of the signal generator:
the signal generator creates the generated signal, and
the noise generator creates generated noise.

6. The method of claim 5, wherein training the signal generator further comprises:
combining the generated signal and the generated noise.

7. The method of claim 5, wherein training the signal generator further comprises:
using generated raw data and a cycle loss constraint.

8. The method of claim 7, wherein the generated raw data comprises the generated noise and a historical signal.

9. The method of claim 1, wherein training the signal generator further comprises:
using a signal discriminator to score the generated signal.

10. The method of claim 9, wherein the signal generator is trained using an imitation constraint.

11. The method of claim 1, wherein the signal generator uses a data model to create the generated signal.

12. The method of claim 11, wherein the data model is a neural network.

13. The method of claim 1,
wherein the raw data is organized into a knowledge graph that comprises a plurality of data domains, and
wherein training the signal generator comprises:
using the raw data to train the signal generator.

14. The method of claim 13, wherein the signal generator uses a first data domain, of the plurality of data domains, to create the generated signal.

15. The method of claim 14, wherein the signal generator uses the first data domain and a second data domain, of the plurality of data domains, to create the generated signal.

16. The method of claim 15,
wherein the first data domain is a frequency domain, and
wherein the second data domain is a spatial domain.

17. The method of claim 15, wherein training the signal generator further comprises:
modifying a data model of the signal generator based on the plurality of data domains.

18. The method of claim 13, wherein a plurality of relationships between data domains, of the plurality of data domains, is defined in the knowledge graph.

19. The method of claim 18, wherein training the signal generator further comprises:
modifying a data model of the signal generator based on the plurality of relationships between the data domains.

20. An information handling system comprising:
memory storing raw data, wherein the raw data comprises a signal and noise; and
a processor, herein the processor is configured to perform a method for creating a generated signal, comprising:
training a signal generator using a physics informed constraint;
providing the raw data to the signal generator, wherein the signal generator processes the raw data to create the generated signal; and
obtaining the generated signal from the signal generator.
